(19) United States
(12) Patent Application Publication
(10) Pub. No.: US 2011/0295400 A1
(43) Pub. Date: Dec. 1, 2011

(54) METHOD FOR PREPARING A PERFUME WITHIN A SYSTEM COMPRISING A PLURALITY OF INTERACTIVE TERMINALS FOR FORMULATING PERFUMES AND A SERVER CONFIGURED TO EXCHANGE DATA WITH THE PLURALITY OF TERMINALS

(75) Inventor: Henri Samain, Bievres (FR)

(73) Assignee: L'OREAL, PARIS (FR)

(21) Appl. No.: 13/129,841

(22) PCT Filed: Nov. 24, 2009
(86) PCT No.: PCT/IB2009/055310

§ 371 Date: Jul. 22, 2011

Related U.S. Application Data
(60) Provisional application No. 61/193,493, filed on Dec. 3, 2008.

(30) Foreign Application Priority Data
Nov. 24, 2008 (FR) 08 57953

(51) Int. Cl. G06F 17/50

(52) U.S. Cl. 700/97

(57) ABSTRACT

A method of dispensing at least one test scent within a system includes a server configured to exchange data with a plurality of interactive scent-formulation terminals, each interactive terminal including a plurality of odorous substances, serving when combined in various proportions to create a plurality of scents; dispenser means for dispensing a selection of the odorous substances out from the terminal; a network interface enabling the terminal to communicate with the server; and a user interface; in which method the server automatically sends data to at least one terminal, the data describing at least one formulation enabling the terminal to dispense a test scent, while leaving the user of the terminal free to select the moment at which the test scent is dispensed.

The present invention relates to the preparation of fragrant compositions, in particular perfumed compositions.

“Professional” solutions exist for creating perfumes, using apparatuses which allow mixing of various essential oils that one chooses to mix. Thus, these apparatuses relieve the professional in his work since he no longer has to manually weigh and mix the ingredients that he wishes to incorporate into the formulation.

Although it may be envisaged that a user who is not knowledgeable in regard to perfume may handle these apparatuses, the result would not be satisfactory. He would very quickly get lost and would not succeed in producing the perfume which he likes. Moreover, the bulkiness and the price, justified by the sophistication, of these apparatuses make individual use very difficult and therefore their use is restricted to professionals.

The question has been asked as to whether it was not conceivable to transpose such a solution to the general public in a simplified version of these apparatuses. In fact, this makes the problem still more difficult since it does not simplify the exercise, it merely limits the means.

Solutions have been sought in which the user will do his own mixing. Indeed, nothing prevents a user from mixing various essential oils, optionally with apparatuses for helping him to weigh and mix the ingredients. It is known that these solutions are not satisfactory since the user does not succeed in easily obtaining the olfactory notes that he is seeking. From time to time, he may obtain a note that he finds pleasant but does not know how to improve it.

The user may, if he wishes to indulge in this exercise, try numerous combinations, thus compensating for his inexperience by the number of trials. In this case, so as not to waste his essential oils and ingredients, he performs mixing trials using small quantities each time. If, as a result of mixing, he succeeds in obtaining a solution that he considers agreeable, it is difficult for him to recollect the various mixing operations that he has carried out and therefore to reproduce it again. Therefore, he has prepared, in general in a small quantity, a mixture which he likes, but which will quickly be depleted. He will be frustrated not to succeed in reproducing his mixture, for example in a large quantity, when it is fully depleted. Certain enthusiasts may like this approach but in general, users do not have the time and the exercise is so irksome and hopeless that they give up very quickly.

Certain apparatuses have been described for helping to produce mixtures, for example in patent U.S. Pat. No. 7,152,758 B2. These apparatuses are intended to receive orders for weighing and mixing essential oils, and carry them out. This is an advance since these tasks may be irksome. However, the solution turns out to be unsuitable since the user does not know how to create and improve his mixtures. It might be thought that by carrying out numerous trials, the user will be able to obtain a mixture that he likes. Unfortunately, through the olfactory organ saturation effect, the idea of carrying out numerous trials is hardly conceivable. Neither does this approach solve the problem of the reproduction, especially in large quantity, of the mixtures which have been retained as being of interest.

Intermediate solutions have been tried. For example, a person asks a professional to produce his perfume. Accordingly, the person is asked to express the perfume that he desires and the professional tries to understand the person's wishes. Unfortunately, this leaves such room for interpretation by the professional that in general this approach does not work. Moreover, it is very expensive on account of the time spent by the professional. The user receives the professional's creation and realizes in general that it does not correspond to his wishes.

In a variant, the person must advise the professional by responding to one or more questionnaires. This leaves room for interpretation by the person confronted with the questionnaire since they do not always properly understand the questions. Once again, such an approach has not been successful.

Whether contact is face to face (in a workshop for example) or takes place via telephone or the Internet, does not change the major issue of interpreting the expression of the user's wishes.

Patent application FR 2 854 253 discloses an installation for ordering fragrance diffusers which allows an application controlling a diffuser to warn a user if substances are lacking on the diffuser and to invite him, if appropriate, to dispose the necessary substances on the diffuser or to order them.

Patent applications US 2004/0235430, US 2006/0062408 and patent U.S. Pat. No. 7,310,539 disclose portable telephones configured to diffuse a fragrance previously associated with a contact of the user of the terminal, during a call from this contact.

Patent application US 2004/0204043 discloses a terminal configured to exchange a fragrant message with another terminal and thereafter to disseminate the message received, by analogy with SMSs. This terminal may further be configured to download a formulation from an Internet site and disseminate it on a terminal.

International patent application WO 2004/043502 discloses a perfume diffusing terminal comprising a microcontroller, reservoirs which have information coded on them identifying the substance contained in the reservoir and a unit for reading this information.

Patent application DE 199 38 405 discloses a terminal comprising a user interface allowing a user to formulate a perfume to be manufactured and several reservoirs of small volume and of bigger volume. The user may manufacture the perfume in small quantities by using the reservoirs of small volume and then, when he likes the perfume, manufacture with the aid of the same terminal the perfume in larger quantities with the aid of the reservoirs of bigger volume.

To summarize, to the knowledge of the Applimayt there is no known solution making it possible to produce, create or tone one's perfume or perfumes in an effective, fast and practical manner.

Therefore, the only solution for a person to obtain a perfume which he likes remains as before to make do with the choice that he or she is offered in shops.

The invention is aimed at remedying all or some of the drawbacks of the prior art.

### SUMMARY

Exemplary embodiments of the invention provide a method for preparing a perfume within a system comprising a plurality of interactive terminals for formulating perfumes and a server configured to exchange data with the plurality of terminals, each terminal comprising:
several fragrant substances making it possible when combined in various proportions to create a plurality of perfumes,
a dispensing means for dispensing a selection of these fragrant substances out of the terminal,
a user interface allowing a user of the terminal to devise, to select and/or to modify from the terminal a formulation of a perfume, this formulation comprising a list of fragrant substances to be combined and,
a network interface allowing the terminal:
   to communicate with the server, so as to transmit to the latter a formulation and/or,
   to receive from the server data describing a formulation reproducible on the terminal on the basis of the fragrant substances available on the terminal or of fragrant substances that may optionally be disposed on the terminal,
      in which method:
a first terminal transmits a formulation to the server and,
a predefined quantity of a perfume corresponding to the formulation transmitted by the first terminal is manufactured and packaged on instructions from the server.

The expression “packaged” should be understood to mean received in a leaktight container, made for example of glass, plastic or metal, so as to allow the manufactured perfume to be kept for at least a fortnight, better a month, better two months. The container has for example a volume of between 1 mL and 2000 mL, or more typically, from 20 mL to 250 mL

The invention also applies to the packaging of the perfume manufactured in cosmetic products, in other fluids such as detergents, as well as in solid articles such as clothes, paper or envelopes.

The invention makes it possible to produce, create or tone one's perfume or perfumes, anywhere, in a practical and effective manner, in the sense that it allows any user, even one with no knowledge about perfumes, to obtain and to improve his perfume or perfumes.

Moreover, the invention may exhibit other advantages, for example that of making it possible to reproduce the formulations retained, of receiving formulations from other people, of exchanging perfumes with other people, of educating oneself in regard to perfume, geared towards the creation of perfumes or the recognition and expression of olfactory notes.

The fragrant substances, the dispensing means, the user interface and the network interface may be grouped together within one and the same terminal, this terminal being different from several mutually remote apparatuses and communicating via a wired or non-wired link.

The invention makes it possible for example, from the point of view of the user of the terminal, to manufacture a perfume remotely on the simple basis of a formulation transmitted by the user.

The expression “reproduce a formulation” should be understood to mean manufacture the perfume corresponding to the formulation with a view to its dissemination or its packaging.

The manufactured and packaged perfume is for example dispatched to a predefined address on instructions from the server. The predefined address is for example the postal address of the user of the first terminal.

As a variant, the predefined address is that of a person other than the user of the first terminal and the invention may be used to deliver or offer perfume.

The formulation transmitted by the first terminal to the server is for example a formulation devised on the first terminal, thereby making it possible, with the aid of one and the same terminal, to devise a formulation and to communicate with the server to have the perfume manufactured and packaged.

The formulation transmitted by the first terminal to the server is for example selected, if appropriate after having been modified, from among one or more formulations transmitted by another terminal of the plurality of terminals to the first terminal, in particular one or more formulations recorded in a memory associated with this other terminal.

The expression “memory associated with a terminal” should be understood to mean a memory integrated into the terminal or a memory situated outside of the terminal and accessible from the latter and/or accessible by the server. It may for example be a mass memory of the server.

According to the invention, the formulation transmitted by the first terminal or server may be adapted so as for example to be packaged in a more dilute or more concentrated form. For this purpose, the server adapts the quantity of solvent, in particular ethanol or water; the fragrant substances being for example left in the same relative proportions. One and the same formulation may be packaged in the form of a perfume bottle, eau de parfum bottle, or aerosol bottle.

The formulation transmitted by the first terminal or server may also be sent in very concentrated form, for certain uses such as the perfuming of cosmetic compositions, such as shampoos, or body creams.

The formulation transmitted by the first terminal to the server is for example a formulation for mood perfuming, the perfuming of detergents and cleaning agents, the perfuming of laundry, sheets, clothes, furniture, vehicles.

As a variant, the formulation transmitted by the first terminal to the server is a formulation selected, if appropriate after having been modified, from among one or more formulations previously transmitted by the server to the first terminal.

User preferences are for example recorded in a memory associated with the first terminal and/or in a database associated with the server and the formulation or formulations previously transmitted by the server to the first terminal are for example determined as a function of the user preferences.

The expression “database associated with the server” should be understood to mean a database integrated into the server or a database situated outside the server and accessible from the latter.

The invention, by making it possible to transmit prior to the manufacture of the perfume, to the terminal, one or more formulations determined as a function of user preferences, allows the user to benefit from formulations suited to his tastes.

The formulation or formulations previously transmitted by the server to the first terminal are for example optimized formulations determined as a function of a formulation devised on the first terminal by the user.

The expression “optimized formulation” designates a formulation determined by the server on the basis of a devised formulation satisfying a predefined acceptance criterion, for example compliance with laws of association of olfactory notes and/or of proportions for employing fragrant substances and/or of compatibility between the fragrant substances.

The invention may then make it possible to enable the user of the terminal to benefit from the knowledge and experience in regard to perfumes of the server and, if appropriate, of a physical person who is an expert in perfumes and interacts with the server, called an “expert” hereinafter.

The formulation or formulations previously transmitted by the server to the first terminal are for example determined as a function of at least one olfactory descriptor present in a request addressed by the first terminal to the server, thereby allowing a user without particular knowledge in terms of fragrant substances to compose formulations of perfumes.

According to one embodiment of the invention, the predefined quantity of perfume is manufactured and packaged by a second terminal of the plurality of interactive terminals, receiving instructions from the server. This second terminal is for example the other terminal mentioned above or any terminal of the plurality of terminals, or indeed even the first terminal.

The second terminal is for example identified in a request transmitted by the first terminal to the server.

As a variant, the server chooses a second terminal on its own initiative.

The formulation or formulations previously transmitted by the server to the first terminal may be determined as a function of the fragrant substances available on the second terminal and/or of substances that may be disposed on the second terminal, thereby making it possible to avoid prompting the user of the first terminal to select and/or to modify a formulation that is not reproducible by the second terminal.

The formulation or formulations previously transmitted by the server to the first terminal are for example determined as a function of several of the factors mentioned above, or indeed even as a function of all the factors mentioned above.

As a variant, the server transmits a request to the second terminal inviting the user of the second terminal to dispose on the second terminal one or more substances not available on the second terminal and listed in a formulation to be manufactured and packaged transmitted by the first terminal to the server.

According to another embodiment of the invention, the predefined quantity of perfume is manufactured and packaged by a perfume manufacturing facility receiving instructions from the server.

Other exemplary embodiments of the invention provide an interactive terminal for formulating perfumes, comprising:
a plurality of fragrant substances making it possible when combined in various proportions to create a plurality of perfumes,
a dispensing means making it possible to dispense a selection of these fragrant substances,
a user interface making it possible to select and/or to modify a formulation of a perfume with a view to the manufacture and packaging of a predefined quantity of the perfume corresponding to this formulation, the formulation comprising a list of substances to be combined, and
a network interface making it possible to receive from a server a formulation to be manufactured and packaged and/or to transmit to the said server a formulation to be manufactured and packaged.

The terminal may comprise means for packaging the perfume, comprising for example at output pads or spaces for receiving one or more bottles.

The dispensing means, the user interface and the network interface may be incorporated in a single terminal, being for example located inside a same housing.

The fragrant substances may be contained in reservoirs that may be placed in the terminal independently of one another.

Other exemplary embodiments of the invention provide a server configured to exchange data with a plurality of interactive terminals for formulating perfumes, each terminal comprising:
several fragrant substances making it possible when combined in various proportions to create a plurality of perfumes,
a dispensing means for dispensing a selection of these fragrant substances out of the terminal,
a user interface allowing a user of the terminal to devise, to select and/or to modify from the terminal a formulation of a perfume, this formulation comprising a list of fragrant substances to be combined and,
a network interface allowing the terminal to communicate with the server, so as to transmit a formulation to the latter and/or to receive from the server data describing a formulation reproducible on the terminal on the basis of the fragrant substances available on the terminal or of fragrant substances that may optionally be disposed on the terminal,
   the server being configured to do at least one of:
transmit to a first terminal one or more formulations determined:
   as a function of user preferences associated with the user of the first terminal and/or,
   as a function of a formulation devised on the first terminal and/or
   as a function of at least one olfactory descriptor contained in a request transmitted by the first terminal to the server and/or
   as a function of fragrant substances available on this first terminal or on a second terminal identified by the first terminal or that may be disposed on the first terminal or on the second terminal,
      and
order the manufacture and the packaging of the perfume corresponding to at least one formulation devised, selected or modified by the first terminal, in particular on the basis of the formulation or formulations transmitted by the server to the first terminal.

The server is for example configured to generate or select formulations as a function of at least one olfactory descriptor contained in a request transmitted by the first terminal to the server.

The server accesses for example a chart for converting between olfactory descriptors and fragrant substances or associations of fragrant substances.

Terminal

The terminal may be embodied in the form of a single apparatus but it would not depart from the framework of the present invention were the terminal to be embodied with the aid of several apparatuses disposed in one and the same spot.

The terminal is for example of reduced size, being for example a portable apparatus, being in particular intended to be handled by a user and being able, if appropriate, to be introduced into a handbag. The terminal may be considered to be the association of a computer, portable or fixed, a game console, portable or not, with an internal extension for example a card, an integrated external extension, or non-integrated external extension.

The terminal comprises for example an integrated autonomous electrical energy source, such as batteries or an accumulator cell.

The terminal comprises for example a plurality of reservoirs, for example more than two, three, five or ten reservoirs, receiving the substances for the preparation of perfumes. The reservoirs are for example mounted in a removable manner in the terminal so as to be able to be replaced during and/or after use of the terminal. The reservoirs are advantageously arranged in such a way that the substances that they contain may be exchanged, replaced or replenished.

The reservoirs may have a capacity of between 0.25 and 50 mL. The reservoirs may comprise main reservoirs whose capacity is between 1 and 50 mL and/or toning reservoirs with a capacity of between 0.25 and 10 mL. The reservoirs are for example other than microcapsules carried by one and the same support.

The term “substance” designates either a pure substance, or a diluted substance, or a mixture of compounds, diluted or not.

A substance may contain between 1 and 50, in particular between 10 and 20 compounds. The substances may be chosen to be portable as such and/or be substances customarily used for the manufacture of perfumes.

The terminal comprises for example a user interface and a network interface. The user interface comprises for example one at least from among a keyboard, a joystick, a touch pad, a screen, optionally touch-sensitive, and a voice recognition system.

The terminal also comprises a means for dispensing, as described later, the substances contained in the reservoirs in chosen proportions.

A memory is for example associated with the terminal, this memory possibly being integrated into the terminal or external to the terminal and accessible by the latter.

The memory may comprise a hard disk, electronic circuits for example of flash memory type or an optical disk reader/burner, inter alia.

The memory associated with the terminal may comprise formulations of perfumes previously sent by the server to the terminal or by at least one second terminal to the said terminal and/or formulations of perfumes sent by the terminal to the server or to a second terminal.

The memory associated with the terminal may also comprise user preferences, for example defined by the user of the terminal and which will be described later.

The terminal may further comprise other modules, as described hereinafter.

The terminal may for example be configured to allow applications other than in relation to the preparation of perfumes.

The terminal also comprises for example a dispensing means specific to make-up perfuming.

Each terminal of the plurality of terminals is for example such as described above.

Server

The term “server” designates one or more programmed computers, capable for example of managing data exchanges with a sizable number of terminals.

A database is for example associated with the server, this database being for example integrated into the server or external to the server and accessible by the latter.

The database may catalogue examples of predefined formulations and/or comprise rules of association advising about the possibility and/or the relevance of associations of substances within various formulations.

The database may also comprise user preferences associated with the users of the terminals.

The server is for example entirely automated, that is to say the analysis of the requests originating from a terminal is performed exclusively without human intervention.

As a variant, the server allows the intervention of an expert specializing in the devising of perfumed compositions.

The server is for example configured to:
receive on the part of a first terminal a request describing a formulation that the user of the first terminal wishes to reproduce, and
analyse the request and schedule the manufacture and the packaging of the perfume corresponding to the formulation.

The formulation described in the request is for example selected or modified on the basis of one or more formulations determined by the server in the course of a prior step and then transmitted to the first terminal.

The server is for example configured to determine, during the prior step, one or more formulations as a function of user preferences for example recorded in a memory associated with the first terminal and/or in a database associated with the server.

The server is for example configured to determine, during this prior step, one or more formulations optimized as a function of a formulation devised on the first terminal. The server evaluates for example whether an acceptability criterion, corresponding for example to compliance with one or more laws of association of olfactory notes and/or of proportions for employing fragrant substances and/or of compatibility between the fragrant substances, is satisfied.

If it turns out that the acceptability criterion is not satisfied, the server determines for example when analysing the request the modification or modifications that may possibly be made to the formulation devised on the first terminal so as to obtain an optimized formulation satisfying the said acceptability criterion.

The optimized formulation differs for example from the formulation devised by:
the addition and/or the deletion of at least one fragrant substance with respect to the formulation devised and/or,
the modification of the proportion of at least one fragrant substance with respect to the formulation devised.

The server may further be configured to determine, during the prior step, one or more formulations as a function of at least one olfactory descriptor present in a request addressed by the first terminal to the server.

The server may also be configured to determine, during the prior step, one or more formulations as a function of the fragrant substances available on a second terminal and/or of substances that may possibly be disposed on this second terminal. As will be seen hereinafter, the server is for example configured to access a lookup table of correspondences between fragrant substances.

The second terminal is for example identified in the request transmitted by the first terminal to the server.

As a variant, the server chooses a second terminal from among the plurality of terminals and transmits the instructions to it allowing the manufacture and the packaging of the perfume. The choice of the second terminal is for example performed as a function of the fragrant substances available on the terminals or else as a function of agreements between the server and certain terminals.

The server is for example configured to address a warning message to the first terminal when one or more substances listed in the formulation determined by the server are not available on the second terminal identified by the first terminal in the request.

The server may also be configured to address to the second terminal a message inviting the user of this second terminal to dispose on the second terminal the fragrant substance or substances not available on the second terminal and listed in the formulation.

When the second terminal comprises an autonomous electrical energy source, the server may also, when analysing the request, interrogate the second terminal about the state of depletion of the autonomous electrical energy source.

The server is for example configured to determine, during the prior step, one or more formulations as a function of at least one olfactory descriptor contained in a request transmitted by the first terminal to the server. The server may generate or select formulations as a function of the olfactory descriptor contained in the request transmitted by the first terminal to the server, for example with the aid of a chart, to which it has access, for converting between olfactory descriptors and fragrant substances or associations of fragrant substances.

According to a first exemplary server according to the invention, the server is not associated with reservoirs receiving fragrant substances nor with a means for dispensing these fragrant substances.

According to another exemplary server according to the invention, the server is associated with reservoirs receiving fragrant substances and with a means for dispensing these fragrant substances. In such a case, the server may, after having analysed the request transmitted by the first terminal, manufacture and package the formulation.

The invention is not limited to a single server.

In a variant, the invention implements several servers communicating with one another and dedicated to different applications. One server is for example dedicated to the preparation of perfumes, and another server is dedicated to the preparation of make-up or of care compositions which may comprise the devised or optimized formulation as perfume.

These various servers may converse with a terminal capable of taking into account several of the applications described above or with terminals dedicated to one of these applications.

As a variant, one and the same server is dedicated to several of the applications described above and the terminals are dedicated to a specific application.

As a variant also, several servers are dedicated to one and the same application, for example to the preparation of perfumes.

The server has for example a different structure from that of the terminals.

Communication Standard for the Formulations

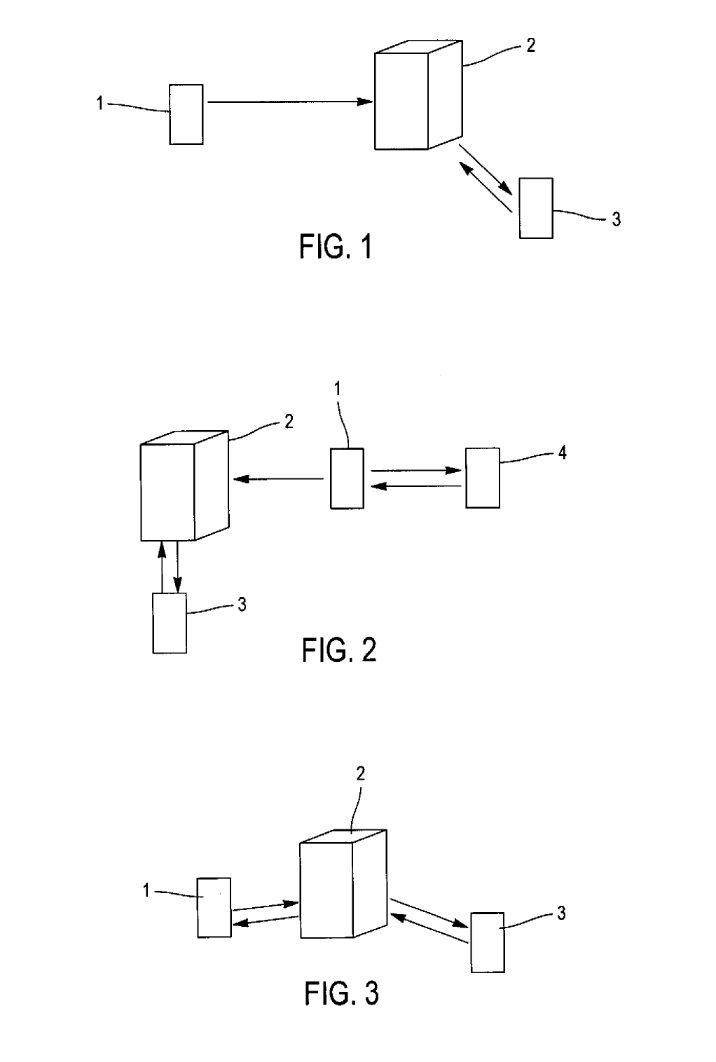

According to an exemplary implementation of the invention, represented in a schematic manner in FIG. 1, the first terminal 1 transmits to the server 2 a request describing a formulation to be reproduced.

The server 2 then transmits this formulation to a second terminal 3, after having verified that the formulation is reproducible on this second terminal 3.

According to another example represented in FIG. 2, the first terminal 1 receives one or more formulations from another terminal 4. These formulations are for example recorded in a memory associated with the other terminal 4 and the other terminal 4 and the first terminal 1 enter for example into communication on account of their geographical proximity. The other terminal 4 allows for example the first terminal 1 to access its user preferences and to download part thereof.

The first terminal 1 may then select or modify one of the formulations received from the other terminal 4 and transmit it to the server 2 which then transmits it to the second terminal 3, which is distinct from the other terminal 4 in the example of FIG. 2.

According to an example not represented, the other terminal and the second terminal are one and the same.

In the example represented in FIG. 3, the server 2 transmits previously to the first terminal 1 one or more formulations from among which the first terminal may make a selection. The selected formulation is thereafter transmitted by the server 2 to the second terminal 3 so that the latter manufactures it and packages it.

In other examples not represented, the formulation of the perfume to be manufactured and packaged is transmitted by the server to a perfume manufacturing facility.

As may be seen in FIGS. 1 to 3, the invention involves the implementation of communications between the first terminal 1, the server 2, the second terminal 3 and, if appropriate, the other terminal 4. The server 2 and the terminals are for example configured to communicate according to a communication standard.

As will be seen hereinafter, the server and each terminal are connected or connectable, the connection being a wired or non-wired connection.

The communication standard comprises for example a protocol for transmitting information making it possible to identify substances and/or describing the content of each substance used in the formulation.

The information making it possible to identify the substance is for example devoid of data describing properties of the substance and comprise for example only a code. The server and/or each terminal is for example configured to convert the code into information about the substance.

According to a first exemplary standard the information making it possible to identify the substance comprises only an item of information about the location of the reservoir containing the substance in each terminal.

According to this first example, the reservoirs containing the substances are for example disposed in a predetermined manner in each terminal.

According to a second exemplary standard, the information making it possible to identify the substance comprises information making it possible to identify a group of substances, for example a palette of substances, and information making it possible to identify the location of the substance inside this group of substances.

According to another exemplary standard, the information makes it possible to identify each substance, independently of the position of the reservoir which contains it on the terminal.

The information relating to the content of a substance in the formulation is preferably the total quantities of these substances in the formulation.

These quantities may be expressed by volume or weight, in a metric or other standard, or proprietary standard.

As a variant, the information about the content of each substance in the formulation comprises one at least of:
the duration of transfer or of flow of the substance from the reservoir containing the substance to the dispensing means,
the force and/or the pressure to be applied to the reservoir containing the substance and/or
the voltage to be applied to an electric actuator making it possible to dispense the substance from the reservoir.

The standard may also comprise for at least one of the substances of the formulation, in particular for each substance of the formulation, at least one of the items of information chosen from the following list: a required heating temperature, the physical state of the substance, such as the viscosity or the colour for example, information about cross-incompatibilities with other substances, a date of use or of manufacture or of expiry of the substance, batch numbers relating to the requirement for traceability, or else risks, if any, associated with the substance, such as allergic risks.

The standard may for example make it possible to code all the information mentioned above, without all this information being systematically contained in the data transmitted during a communication.

The information transmitted comprises for example information relating to the perfume obtained, independently of a particular substance, for example one at least of the items of information chosen from the following list: a temperature of heating or other stimulation, a rate or conditions of stirring or resting times for the perfume, the order of addition of the substances during the reproduction of the formulation, information about the physical state of the perfume, such as its viscosity, its colour or its stability for example, a date of use, of manufacture or of expiry of the perfume, any risks, such as allergic risks.

The information transmitted according to the communication protocol may further comprise for example information relating to the destination of the perfume according to the formulation, for example if the perfume must be introduced into a solvent, or into a product such as for example a cosmetic product, food, fuel, fluid for cleaning, laundry, floors, crockery. Such information may further pertain to the designation of the parts of the body to which the perfume should be applied, in particular the neck, the head, the armpits, the feet or certain objects, such as clothes, shoes, furniture, or else cars.

The information transmitted may also comprise information making it possible to know whether the perfume according to the formulation should be dispensed with a dispenser or a passive or active diffuser, for example electrical, thermal or spray.

The information may specify whether the formulation to be reproduced is intended for a man, a woman or a child, or else whether the perfume according to the formulation is intended for a particular age class.

The transmission standard may provide for an item of information specifying whether the perfume according to the formulation is intended for groups such as those that may be defined by a common affinity to consumer products, artistic products, actors, singers or personalities, or else whether the perfume according to the formulation is intended for a given person, a group of given people, a family.

The transmission standard may further comprise information identifying all the substances contained in the reservoirs of the first terminal as well as their quantity remaining in the reservoirs.

The information transmitted may also identify the substances present in the reservoirs of the second terminal. If appropriate, this information also comprises the quantities remaining of the substances in the reservoirs of the second terminal.

The information transmitted may relate to the context in which the user of a terminal finds him or herself, such as for example the ambient temperature, the ambient humidity, the ambient fragrance, the time, taking account of the time shift, if appropriate.

The information transmitted may also pertain to the operation of the terminal. Such information is for example obtained by a test of auto operation, which is performed systematically upon turning the terminal on, or periodically. This information pertains for example to the rate of fluid flow within the terminal, to the operation and/or malfunctioning of certain modules of the terminal.

The communication standard may also provide for information, grouped together in a header or in several parts, relating to the progress of the communication. This information comprises for example information relating to the identification of the first terminal and/or of a user of the latter, to the identification of the server, to the identification of the second terminal and of the other terminal, to the identification of the date and/or of the communication, to an identification on a work session, on the first terminal or on the server, to an encryption system ensuring the confidentiality of the information.

As has been seen previously, the identification of the substances and their quantity remaining may be represented by distinct parameters. The header may comprise information specifying which are the parameter or parameters adopted for identifying the substances and/or quantifying the substance or substances in the formulation, such information allowing each terminal and/or the server to interpret the data transmitted during the communication.

As will be seen hereinafter, each terminal and the server are for example configured to operate according to several modes of reproduction differing inter alia by the quantity of perfume manufactured and the information transmitted comprises for example information making it possible to identify the mode of reproduction and, therefore, the quantity of perfume to be manufactured.

If appropriate, several communication standards are predefined and each terminal and/or the server may comprise a module for converting from one standard to another.

Substances

As already mentioned, each terminal advantageously comprises a plurality of reservoirs receiving substances for the preparation of a perfume. Each terminal comprises for example several tens of reservoirs. Each reservoir may contain a different substance. As a variant, one and the same substance may be present in various reservoirs of one and the same apparatus, if appropriate, with different concentrations.

The server may be associated with a plurality of reservoirs.

The substances may be present in the fluid state, for example liquid, in all the reservoirs.

As a variant, at least part of the reservoirs comprises a substrate on which one or more substances are adsorbed.

All the substances contained may be fragrant.

As fragrant substance, it is possible to use compounds or aromas of natural or synthetic origin and mixtures thereof.

As compounds or aromas of natural origin mention may be made for example of extracts of flowers (lily, lavender, rose, jasmine, ylang-ylang), of stems and of leaves (patchouli, geranium, petitgrain), of fruits (coriander, anise, cumin, juniper), of fruit peels (bergamot, lemon, orange), of roots (angelica, celery, cardamom, iris, sweet rush), of wood (pine wood, sandalwood, guaiac, pink cedar), of herbs and grasses (tarragon, lemon grass, sage, thyme), of needles and branches (spruce, fir, pine, dwarf pine), of resins and balsams (galbanum, elemi, benzoin, myrrh, frankincense, opopanax).

As compounds of synthetic origin mention may be made for example of compounds of the ester, ether, aldehyde, ketone, aromatic alcohol and hydrocarbon type, and mixtures thereof.

As esters mention may be made in particular of benzyl acetate, benzyl benzoate, phenoxyethyl isobutyrate, p-tert-butylcyclohexyl acetate, citronellyl acetate, citronellyl formate, geranyl acetate, linalyl acetate, dimethyl-benzylcarbinyl acetate, phenylethyl acetate, linalyl benzoate, benzyl formate, ethylmethylphenyl glycinate, alkylcyclohexyl propionate, styralyl propionate and benzyl salicylate.

As ethers mention may be made of benzylethylether.

As aldehydes mention may be made for example of linear alkanals comprising 8 to 18 carbon atoms, citral, citronellal, citronellyloxyacetaldehyde, cyclamenaldehyde, hydroxycitronellal, lilial and bourgeonal.

As ketones mention may be made for example of ionones such as alpha-isomethylionone, and methylcedrylketone.

Among aromatic and in particular terpenic alcohols mention may be made of anethol, citronellol, eugenol, isoeugenol, geraniol, linalol, phenylethylalcohol and terpineol.

As hydrocarbons mention may be made in particular of terpenes.

Moreover, it is also possible to use essential oils, components of aromas, such as for example the essences of sage, camomile, clove, melissa, mint, cinnamon tree leaves, flowers of linden, juniper, vetiver, frankincense, galbanum, labolanum and lavandin.

Used for example as perfume, alone or as a mixture, are: bergamot essence, dihydromyrcenol, lilial, lyral, citronellol, phenylethyl alcohol, alpha-hexylcinnamaldehyde, geraniol, benzylacetone, cyclamenaldehyde, linalol, ambroxan, indole, hedione, sandelice, essences of lemon, mandarin and orange, allylamine glycolate, cyclovertal, lavandin essence, sage essence, betadamascone, geranium essence, cyclohexyl salicylate, phenylacetic acid, geranyl acetate, benzyl acetate, rose oxide.

As a variant, a part of the substances contained is non-fragrant, one reservoir containing for example a non-fragrant substance.

As a further variant, one or more reservoirs may contain a substance intended to become fragrant after a physical transformation.

Some of the reservoirs may contain substances being adjuvants, such as dyes, preservatives, or rheology agents for example.

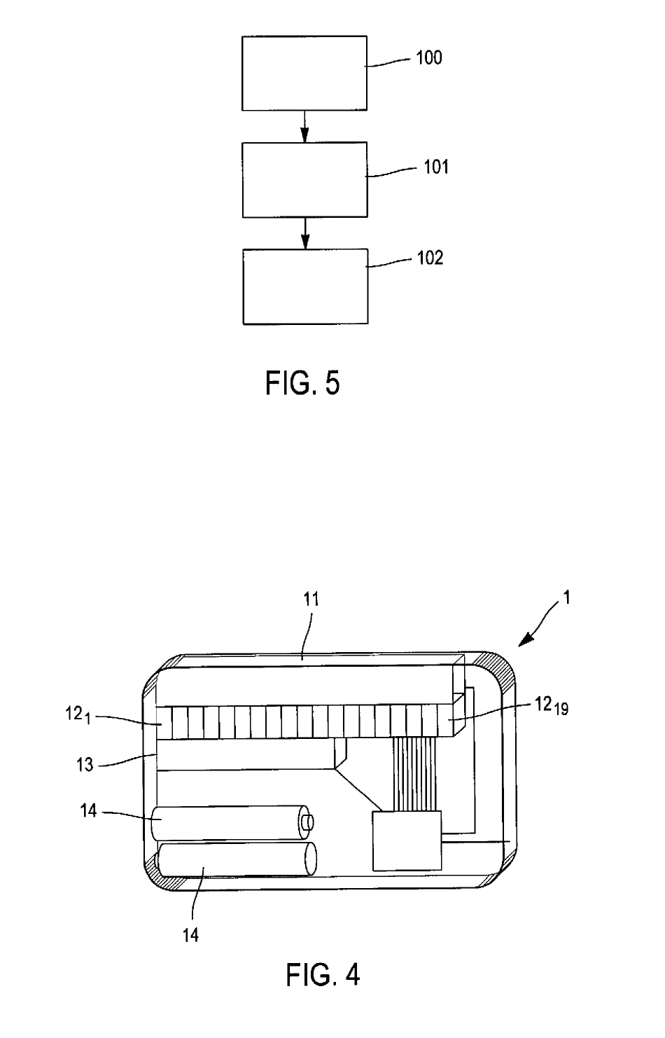

An exemplary terminal 1 according to the invention has been represented in FIG. 4.

As may be seen, the terminal 1 may comprise two types of reservoirs: at least one main reservoir 11 and a plurality of toning reservoirs 12ᵢ.

In the example described, the terminal 1 comprises only one main reservoir 11 and 19 toning reservoirs 12₁ to 12₁₉.

The expression “main reservoir” designates a reservoir containing sophisticated combinations of fragrant substances, for example more than five, ten or fifteen fragrant substances. Such combinations may be considered to be perfumes, or simple compositions of perfume. The capacity of a main reservoir is for example between 1 and 50 mL, for example equal to 10 mL

The expression “toning reservoir” designates a reservoir containing typed fragrant substances. The term typed fragrant substances refers to substances the addition of which may markedly modify the fragrance of the main reservoir. The toning reservoirs may be chosen from among the tones used in perfumery, namely: marine, hesperides, floral, fruity, chypre, gourmand, leather, woody tone. In particular, these tones may be sufficiently concentrated such that the addition of a small quantity markedly modifies the fragrance of the toning reservoir. The capacity of a toning reservoir is for example between 0.25 mL and 10 mL.

The toning reservoirs may contain one at least from among:
a substance with a floral dominant, such as the absolute of jasmine or lilial,
a substance with an oriental dominant, such as patchoulol,
a substance with a hesperides dominant, such as an essential oil of lemon, bergamot or neroli,
a substance with a fruity dominant, such as gamma-decalactone,
a substance with a gourmand dominant, such as ethylmaltol or ethylvanillin
   a substance with a woody dominant, originating for example from sandalwood, cedar wood, or vetiver wood,
   a substance with a hesperides dominant, such as an essential oil of lemon, an essential oil of bergamot, of neroli,
   a substance with a musky dominant, such as white musk, galaxolide, and
   a substance with a marine dominant, such as calone.

In a general way, the terminal may comprise for example between one and ten main reservoirs, in particular between one and four, and between ten and forty toning reservoirs.

As may be seen, the terminal 1 may further comprise a reservoir 13 containing a rinsing liquid, which will be described subsequently.

Also represented in this FIG. 4 is an autonomous electrical energy source for the terminal 1, in the example described two batteries 14.

At least one reservoir may be divided into several sub-parts.

The substances are for example fluid, in particular not very viscous liquids.

At least one reservoir may receive the following composition:
5 to 50% of fragrant substance,
0 to 5% of preservative-assisting substance,
0 to 20% of rheology-assisting substance,
0 to 2% of colour-assisting substance, and
23 to 95% of solvent

The solvent or solvents are for example chosen from among water, ethanol, acetone and other polar organic solvents.

One at least of the substances may also be chosen from among those advocated for the treatment of pathologies, infectious or non-infectious, such as respiratory complaints for example asthma, or skin complaints.

At least one of the substances is for example chosen from among those which, while being fragrant, are advocated for the treatment of pathology or indicated as relaxants or stimulants. Such substances may be natural substances, for example based on natural essences or essential oils, of for example thyme, incense or else eucalyptus.

User Interface

The user interface of each terminal comprises for example a screen on which a formulation selected by the user is displayed.

The terminal may furthermore or as a variant comprise a printer.

The user interface comprises for example one or more keys allowing the user of a terminal to devise a formulation. The fragrant substances are for example displayed on the screen and the user may increase or decrease in the formulation the quantity of a substance, or add or remove a substance in the formulation with the aid of the keys or by acting on a touch screen.

The user interface is for example configured to prompt the user by proposing one at least of the following actions:
increase or limit the top, heart or background notes of the perfume,
play with the parameters commonly used by perfumers such as: hesperides, musky, woody, flowery tones,
play with the parameters used in everyday language, namely the concepts “green”, “sensuous”, “light”,
play with the parameters used in respect of food such as “sweet”, “peppery” etc.,
play with fragrances retrieved from nature such as those of flowers, trees, earths etc.,
play with the fragrances of the major perfume references or fragrances of fragrant products for example.

The user interface may further be configured to allow the user to enter user preferences.

The server may also comprise a user interface such as described above. This user interface allows for example the expert associated with the server to design an optimized formulation on the basis of a devised formulation, this optimized formulation differing from the devised formulation by the addition or the deletion of at least one substance with respect to the devised formulation and/or by the modification of the quantity of at least one substance with respect to the devised formulation.

As a variant, the user interface of each terminal and, if appropriate, of the computer of the server is configured to allow the user and/or the expert to enter one or more olfactory descriptors associated with the perfume to be prepared, this or these descriptors being able to be converted with the aid of a conversion chart into substances so as to lead to at least one formulation.

The conversion chart may be contained in a memory associated with the terminal.

As a variant, the conversion chart is contained in the database associated with the server.

By virtue of the conversion chart, the olfactory descriptors entered by the user and/or the expert by means of the user interface may be translated into substances.

The conversion chart may also be programmed by the user and/or the expert. Because of their personal experience, the user and/or the expert may associate certain fragrance tones with olfactory descriptors and these descriptors may be added to the conversion chart, after having been previously defined, and this may make it possible to customize the conversion chart.

The customized conversion chart may be transmitted by the first terminal to the server, when the request is sent, and the devised and/or optimized formulation may be expressed as a function of this customized conversion chart.

The conversion chart may also be exchanged between the first terminal and a second terminal.

The user interface is for example also configured to allow the user to adjust the magnitude of the modifications to be made by the server to the devised formulation so as to determine the optimized formulation. For example, the user of the terminal may wish the devised formulation to be only slightly modified by the server.

The user interface may allow the user to accompany the sending of a formulation with a message, or, if appropriate, to send only a message. This message may comprise an explanation of a refusal by the user of the terminal to reproduce an optimized formulation.

The user interface of a terminal is for example arranged in such a way that the terminal may reproduce in slave mode the formulations received from a single click.

In a particular case, the optimized formulation is reproduced by mixing at least two predefined formulations. The user interface makes it possible for example in such a case to select the proportions of each of the predefined formulations in the optimized formulation.

Each terminal may comprise artificial intelligence modules for helping to determine the formulation or formulations and/or prohibit or advise against certain formulations or modifications of formulations.

Each terminal may be configured to execute a program bringing about the display on the screen of the user interface:
of a number of points corresponding to the number of main reservoirs of the terminal and,
of a number of vectors corresponding to the number of toning reservoirs of the terminal starting from each point displayed on the screen.

Such a user interface may allow a clear representation of the possibilities of formulation on the basis of the substances available on the terminal.

The user interface of the terminal is for example configured to allow the user to select at least one mode of reproduction, as described hereinafter.

Storage of the Substances and Formulations

One or more memories, that will be designated globally by “memory”, may be associated with the terminal and/or with the server.

The memory may be of any known type, for example electronic, optical or electromagnetic.

The memory may be permanent or erasable and may be access protected.

The memory may be fixed enduringly on the terminal. As a variant, the memory is detachable from the terminal.

The memory may comprise information relating to the substances present in the reservoirs of the terminal and/or to the remaining quantities of these substances in the reservoirs.

Furthermore, the information recorded in the memory associated with the first terminal may comprise formulations of perfumes previously sent by the server to the first terminal or by at least one second terminal to the first terminal and/or formulations of perfumes sent by the first terminal to the server or to a second terminal.

The formulations recorded in the memory of the terminal may further comprise hidden formulations, stored in the memory during the manufacture of the terminal and being accessible only with the aid of a code, this code being for example transmitted by the server to the terminal.

The recorded information may also comprise the dates of reproduction of the formulations previously received or of use of the previously reproduced formulations, as well as the comments received from the server in relation to these formulations, such as assessments for example.

The information recorded in the memory of the first terminal comprises for example the list of substances available in the reservoirs of at least one second terminal.

The user preferences may also be recorded in the memory.

These user preferences comprise for example the previous choices of the user of the terminal, the logic of the mixtures of perfumes and optionally perfume fashion trends, selected by this user. The user preferences may further comprise information relating to the context in which the user of the terminal finds him or herself, such as for example the ambient temperature, the ambient humidity, the ambient fragrance, the time.

The user preferences may further comprise information specifying whether the perfume according to the formulation to be reproduced is intended for a man, a woman or a child, or else whether the perfume according to the formulation is intended for a particular age class, as well as information specifying whether the formulation is intended for groups such as those that may be defined by a common affinity to consumer products, artistic products, actors, singers or personalities, or else whether the perfume according to the formulation is intended for a given person, a group of given people, a family.

The user preferences may further comprise information indicating a predefined address to which the manufactured and packaged perfume should be dispatched.

One and the same terminal may be associated with various users and the memory associated with this terminal may be divided into sub-memories, each sub-memory being associated with a user and containing the formulations reproduced and/or devised by this user.

One and the same memory may be associated with several terminals and this memory is for example divided into units, each unit being associated with a terminal and containing the information mentioned above.

If appropriate, at least one of the terminals of the plurality of terminals associated with the memory is used by various users and the unit in question is divided into sub-units, in the manner of the sub-memories described previously.

The memory associated with a terminal may be accessible to the server or to a terminal distinct from the said terminal, the first terminal and/or the server being able for example to access the formulations recorded in the memory associated with a second terminal.

The database associated with the server may store the formulations previously sent by the server to the first terminal or to at least one second terminal and/or the formulations sent by the first terminal or a second terminal to the server. If appropriate, the assessments sent by the first terminal with the formulation may also be stored in the database.

When the server is associated with reservoirs containing substances for the reproduction of a formulation and with a means for dispensing such substances, the database may also store the substances which the server has at its disposal. The database may also store the substances available on the first terminal and, optionally, on one or more second terminals, as well as their remaining quantity.

The database may further store the date on which substances were bought by the user of the terminal, the expiry date for these substances and the date on which these substances were disposed on the terminal by the user thereof.

The information relating to the substances available on the terminal may be updated after the reception of information entered on the user interface of the terminal by the user or else from a central facility for sending substances.

The database may further comprise a table of correspondences between fragrant substances, as described hereinafter.

The memory associated with the terminal and/or the database associated with the server may form the subject, at least in part, of commercial exchanges.

During such exchanges, the memory and/or database part exchanged may be accompanied by component third parties such as decryption keys, user leaflets, a protective casing, fragrant samples, suggestions of use or of accessories, accessory products such as those intended to receive the formulation, for example a dispensing system, products, clothes etc.

The memory and/or the database are for example addressable.

The memory allows for example the user of the first terminal to retrace his footsteps during a process of devising a formulation, to restart at a particular prerecorded stage in the process of designing a formulation or else to access any formulation in memory.

Each terminal may be associated with a memory such as described above.

If appropriate, the user of a terminal and the server may access the information recorded in a database associated with other servers.

Identification of the Available Substances

According to an exemplary implementation of the invention, each terminal benefits only from information relating to the location of the reservoirs within the terminal. If the reservoirs are not correctly disposed, the final fragrance will not be the one expected.

According to another exemplary implementation of the invention, each terminal comprises a system for identifying the reservoirs available.

The identification system may be of any type and comprise an identifier device and an identifier.

The identifier device is for example secured to a terminal. The identifier may be secured to the packaging device containing the substance and optionally be placed in the reservoir.

The identification system implements for example:
radio waves, in particular RFID microchips,
optical identification such as bar codes, or colours,
electrical or electronic connectors,
reliefs.

The identifier is for example placed on or under or on the side of the reservoir containing the substance.

Each terminal may comprise as many identifier devices as reservoirs. As a variant, the number of identifier devices is less than the number of reservoirs.

In another variant, each terminal comprises only one identifier device common to all the reservoirs.

In the case where the identification system implements RFID microchips, the identifier device may comprise just a single emitting antenna sequentially addressing the identifiers which take the form of RFID microchips.

In the case of an optical identification system, the identifier device may comprise just a mobile reader that is able to read, by displacement, the identifier associated with each of the reservoirs.

In another variant, the identifier device is fixed with respect to the terminal and each terminal is configured to displace the reservoir, in such a way that the identifier of the said substance is read by the identifier device, before the substance is placed in order to fill it in a selected reservoir. As a variant, the user presents a substance in front of the identifier device so as to allow the identifier device to identify the substance, and then the user fills the reservoir with the substance. Each terminal may thus be advised manually or automatically about the location of the reservoir in which the substance is placed.

The reservoirs may be presented one after another in front of the identifier device, so that the substances are placed therein in a given order.

Each terminal comprises for example a system configured to provide a luminous indication guiding the filling of the reservoirs. As a variant, the filling of the reservoirs is performed with the aid of a rotating reservoir door.

Each terminal is for example configured to automatically identify the substances placed in the reservoirs.

The identification system may also be configured to make it possible to evaluate the quantity of at least one substance in the reservoir receiving it. The identification system comprises for example means for performing an optical measurement, a measurement of conductivity or pressure or a gravimetric measurement.

As a variant, the identification system comprises one or more chemical receptors, disposed for example above the substances and verifying the presence of the substances by an analytical procedure.

The identification system may for example be configured to indicate to the user of the terminal that certain reservoirs are empty or full.

Calculations of the Quantities

Each terminal may operate according to several modes of reproduction, each mode of reproduction being associated with a predefined quantity of formulation to be reproduced.

The reservoirs usable to reproduce a formulation may be the same, independently of the chosen mode of reproduction. In contradistinction to the device described in patent application DE 199 38 405, it is not necessary to provide specific reservoirs for each mode of reproduction, these reservoirs differing by their capacity.

According to a “trial” mode of reproduction, a very small quantity of perfume is for example prepared, for example between 0.01 mg and 10 mg.

According to a “perfuming” mode of reproduction, a quantity of between 10 mg and 2 g for example is prepared.

Finally, according to a “manufacturing” mode of reproduction, a quantity of for example between 2 g and 200 g is prepared.

The “trial” mode of reproduction is for example suited to the reproduction of formulations at the design stage or to the reproduction of formulations corresponding to a proposal received.

The “perfuming” mode of reproduction is for example suited to the reproduction of a formulation resulting from the collaboration between the user of a terminal and the expert associated with the server.

Finally, the “manufacturing” mode of reproduction makes it possible for example to prepare a formulation approved by the expert and the user, and that the latter wishes to use for several days for example.

The user interface may allow the user to indicate whether he wishes the formulation to be reproduced in one or more goes. For example, according to the “perfuming” mode of reproduction, the user may act on the user interface of the terminal so that the reproduction is carried out in four goes 0.05 g of perfume are for example prepared at each go and deposited on four different parts of the body.

Likewise, the reproduction of a formulation according to the “trial” mode of reproduction may be performed in several goes, from 1 to 10 mg of perfume being for example prepared at each go.

Dispensing Means

The means for dispensing the substances is for example configured to exhibit a flow rate of between 1 mg per second and 10 g per second, in particular between 10 mg per second and 1 g per second.

The dispensing means is for example similar to those used for example in microfluidics and in particular electrostatic microfluidics, and may make it possible to dispense the perfume for example in the form of a drop or a jet of liquid.

A dispensing means according to the invention may comprise controllable pipes and valves for dispensing small volumes, with flow rates ranging from a few microlitres per second or less, to a few millilitres per second.

A dispensing means according to the invention may be made at least in part, in particular entirely, from plastic, ceramic or metal. It may also be covered at least partially with a material such as an anti-stick material e.g. a fluorinated or silica coating.

The dispensing means may be obtained by moulding, etching, or assembling.

The valves may be controlled mechanically, by applying a pressure or through the use of cables to be pulled, electromechanically, magnetically, thermally using the expansion property of materials subjected to heat, selectively obstructing the passage of the substance.

The dispensing means according to the invention may as a variant comprise valves based on materials of the piezoelectric type or actuator based on conducting polymer or dielectric elastomer.

The actuation of the valves is for example carried out in an electrical manner, for example using low voltages, in particular less than 10V.

In a particular exemplary implementation of the invention, the dispensing means is devoid of valves, the triggering of the motion of the substance contained in a reservoir being conditioned by the exerting of a user action, for example pressing on a wall of the reservoir.

The force allowing the displacement of the substance contained in the reservoir when a valve is opened may correspond to a continuous pressure on all the reservoirs of the terminal or to a pressure only applied at the moment of actuation of the reservoir.

The dispensing means comprises for example one or more pistons, in particular a piston displaced by an electrical force.

As a variant, the dispensing means comprises one or more pumps or bladed wheels, or small size screws for exerting a force on the reservoir, allowing the displacement of the substance.

As a further variant, the dispensing means comprises means for heating the reservoir, and this may make it possible to expand walls of the reservoirs, or the substance or substances or gas present in the reservoir.

In another variant, the dispensing means comprises means configured to generate by pneumatic effect the force allowing the displacement of the substance contained in the reservoir. The reservoir comprises for example an intake for air for example or a liquefied gas that expands.

As a further variant, the dispensing means comprises one or more electric motors, for example a stepper motor for generating the force allowing the displacement of the substance, or assisting the motion of the substance.

The force allowing the displacement of the substance may be applied directly to the substance, or indirectly, being for example applied to a flexible wall.

The fluid or fluids set into motion by the dispensing means may be dispensed to an output of the terminal, the mixing taking place at said output. As a variant, the dispensing means comprises one or more mixing chambers and the substance or substances are directed towards this or these mixing chambers.

The dispensing means may further comprise means for generating in the mixing chamber or chambers one at least of the following actions: heating, cooling, pressurization, depressurization, blending or else flow of a third-party substance.

The dispensing means may further comprise a stirring unit, for example a ball, chicanes, or a mobile stirrer driven in motion.

The dispensing means may further comprise means for rinsing the pipes and/or the mixing chamber or chambers. These means allow for example the flow of a liquid, of a gas, liquefied or pressurized, or of a bottle brush for example.

In addition to the previously described reservoirs containing the substances intended for the reproduction of one or more formulations, the terminal may further comprise at least one reservoir 13 for a rinsing fluid, represented in FIG. 4, and at least one reservoir for a pressurization fluid.

Similarly to what was previously described with reference to the reservoirs receiving the substances of the formulation, the terminal may also be configured to make it possible to evaluate the quantity of the rinsing fluid or of the pressurization fluid in the corresponding reservoir.

The dispensing means may further comprise at least one standby chamber and one or more valves allowing the transfer of a first intermediate perfume resulting from the reproduction of a first formulation stored in the standby chamber, thereby making it possible for example to prepare a perfume by mixing the first perfume stored in the standby chamber and a second intermediate perfume, resulting from the reproduction of a second formulation, carried out subsequent to the reproduction of the first formulation.

The user interface is for example configured to allow the user of the terminal to actuate the various elements of the above-described dispensing means. This interface is advantageously suited to the embodiment chosen to embody the dispensing means. The user interface is for example electronic and integrates autochecking systems associated with power stages of the first terminal.

The terminal may comprise several distinct dispensing means, for example dispensing means specific to each mode of reproduction.

The terminal may comprise various parts, for example a main body comprising the user interface and the network interface and one or more ancillary bodies comprising all or part of the dispensing means, the ancillary body or bodies being for example detachable from the main body.

The main body is for example further configured to allow the user to confirm the choice of the formulation to be reproduced and/or the quantity of perfume to be prepared.

The terminal may comprise one or more perfume outputs.

A perfume output is for example associated with a single dispensing means.

As a variant, at least two dispensing means share one and the same perfume output.

The main body may, prior to the reproduction of the formulation, indicate to the user which perfume output will be the one used.

The perfume output may comprise a dispensing nozzle and, if appropriate, application means, such as a felt or paper wipes, the latter being cleanable or purgeable.

The perfume output may also comprise a pressure- or vacuum-based active discharging system.

The dispensing means described above may be integrated into a terminal or be associated with the server.

The perfume output may be equipped, if appropriate, with an atomizing means, for example piezoelectric.

The dispensing means may also act by evaporation

Reproduction of the Formulations

By virtue of the invention, the user of the terminal may reproduce formulations. These formulations may be reproduced by the server, if appropriate.

As a variant, the formulations may be reproduced by a second terminal, as in the example represented in FIG. 5.

In a step 100, the adjustment of the quantities of each substance according to the formulation and of the quantity of perfume to be prepared according to the mode of reproduction is performed automatically by the second terminal which executes adjustment instructions transmitted by the server.

As a variant, during this step, the user of the second terminal undertakes the adjustment of the volume or of the weight of each substance and/or of the perfume.

In the example illustrated, it is assumed that all the substances listed in the formulation to be reproduced are available on the second terminal.

In step 101, the dispensing means of the second terminal is actuated so as to dispense the substances according to the quantities determined in step 100. This actuation may be carried out on the initiative of the user of the second terminal or automatically.

Finally, in step 102, the dispensed substances are mixed so as to obtain the perfume according to the formulation at a perfume output of the terminal.

In an optional manner, during a step, not represented, that may occur before step 102, operations of dilution with a solvent, or a gas or operations of concentrations, for example evaporations, are carried out on the perfume or on the one or more substances.

Other operations, such as a UV irradiation, for example for sterilization purposes or to activate reactions, or a heating may be performed. These operations may be done on the substances, on the result of the mixing, and/or on the various parts of the first terminal, such as the pipes, mixing chambers, valves, gates etc.

As will be seen hereinafter, when the second terminal does not contain all the substances for the reproduction of the formulation, the second terminal may request the sending of the missing substances or the server may choose another second terminal to reproduce the formulation.

If appropriate, the server is associated with reservoirs containing the substances and a dispensing means making it possible to reproduce the perfume according to the formulation considered and the reproduction of this formulation is performed by the server.

Independently of the perfume manufacture and packaging, neither the terminals, nor the server may for example determine formulations, the only formulations implemented being prerecorded in the memory associated with at least one, or indeed each terminal, or in the database associated with the server. Hidden formulations are for example recorded in the memory associated with the first terminal and are accessible only after the reception by the first terminal of a code transmitted for example by the server.

As a variant, the determination of the formulations is for example carried out exclusively by the terminals and/or the server, without human intervention. As a variant, the determination of at least one formulation involves the user of the first terminal and/or the expert associated with the server.

For example, only the terminals may determine formulations, the server being able to implement only prerecorded formulations.

As a variant, the server may determine formulations, but not the terminals.

According to another exemplary implementation of the invention, the server and the terminals may determine formulations.

The terminals and/or the server may also reproduce formulations that they have determined.

Operation in Slave Mode

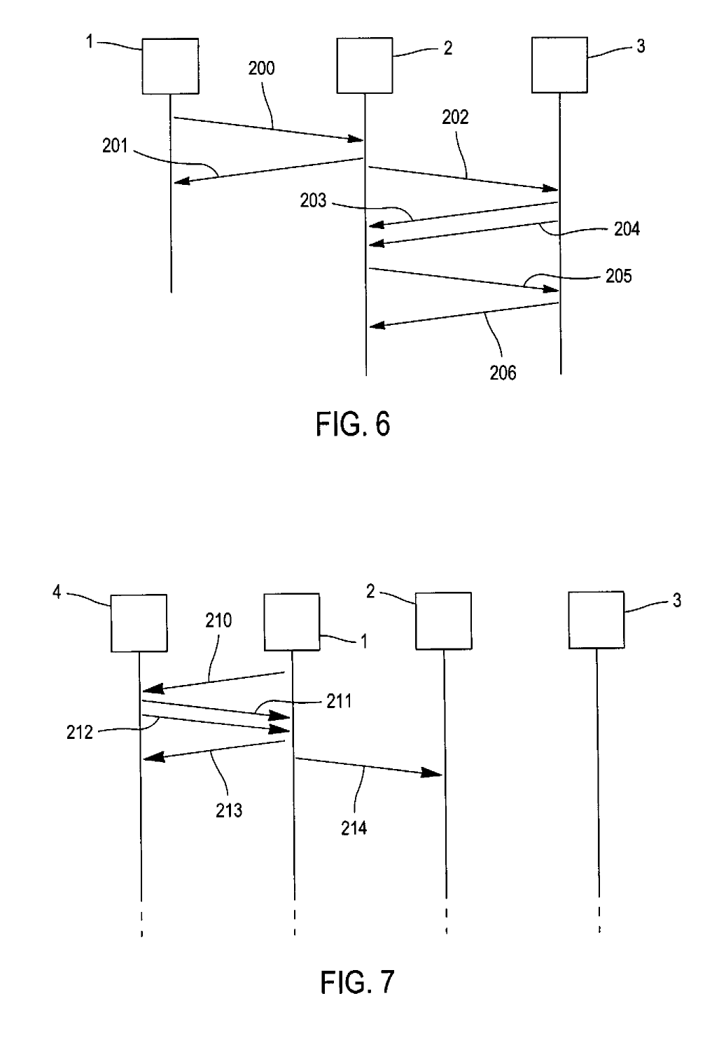

A first exemplary application of the invention to the reproduction of a formulation in slave mode by a second terminal on request from the first terminal will now be described with reference to FIG. 6.

The first terminal 1 sends a request 200 to the server 2 describing a formulation to be reproduced, the chosen mode of reproduction and identifying a second terminal 3.

This formulation to be reproduced is for example selected or modified from among one or more formulations determined by the server 2 as a function of one of the factors previously mentioned and corresponding to exchanges, not represented, between the server 2 and the first terminal 1.

The server 2 sends an acknowledgement message 201 to the first terminal 1.

The server 2 analyses the request 200 and interrogates the second terminal 3 identified in the request 200 about the availability on this terminal of the fragrant substances listed in the formulation to be reproduced by the sending of a request 202.

The second terminal sends an acknowledgement message 203 and then a request 204 identifying the compounds available on the second terminal 3.

When all the substances listed in the formulation to be reproduced are identified as available on the second terminal 3, the server 2 thereafter transmits a request 205 to the second terminal 3 describing the formulation received and the chosen mode of reproduction and the second terminal 3 sends an acknowledgement message 206. The second terminal thereafter reproduces the formulation according to the instructions of the request 205 by performing steps 100 to 102 described with reference to FIG. 5.

This reproduction may or may not be subject to the agreement of the user of the second terminal.

The reproduction in slave mode may as a variant be carried out by the server, on the initiative of the first terminal.

A second exemplary application of the invention to the reproduction of a formulation in slave mode by another terminal on request from the first terminal will now be described with reference to FIG. 7.

The user of the first terminal is situated for example in proximity to a user of another terminal, smells his or her perfume and decides to reproduce it.

The user of the first terminal then sends a request 210 to the other terminal requesting the transmission of the formulation corresponding to the perfume smelt.

The other terminal 4 sends an acknowledgement message 211.

The other terminal 4 thereafter transmits to the first terminal 1 a request 212 which describes the formulation corresponding to the perfume smelt.

The first terminal 1 then sends an acknowledgement message 213 to the other terminal and then a request 214 to the server 2, which is for example similar to the request 200 described with reference to FIG. 5 and which leads to the same exchanges between the first terminal 1 and the server 2 on the one hand and between the server 2 and the second terminal 3 on the other hand.

In a variant, not represented, the perfume corresponding to the formulation is reproduced by the other terminal 4.

Comparison Between the Formulation and the Available Substances. Tables of Correspondences to Cope with Missing Substances

As already mentioned, the request sent by the second terminal to the server may comprise information identifying the substances available on the second terminal and the server may be configured to compare, during the analysis of this information, the fragrant substances listed in the predefined formulation that the server proposes to send to the second terminal or in the optimized formulation produced on the basis of a formulation devised by the first terminal and contained in the request sent by the first terminal with the fragrant substances identified as available on the second terminal.

According to a first exemplary configuration of the server, the latter determines one or more formulations by taking account only of the substances identified as available on the second terminal in the request sent by the second terminal.

According to a second exemplary configuration of the server, the latter determines one or more formulations by taking account of the substances identified as available on the second terminal in the request sent by the second terminal and, if appropriate, of one or more substances not identified as available on the second terminal.

In such a case, the server may interrupt the analysis, and send an alert message to the second terminal signalling the absence of certain substances.

As a variant, the database comprises a table of correspondences between various fragrant substances as a function of physico-chemical properties common to these substances, and the server determines at least one formulation or modifies the devised formulation by comparing the substances available on the second terminal and the substances of the formulation to be reproduced and replaces with the aid of the table of correspondences the substance or substances of the said formulation identified as not available on the second terminal by a substance identified as available on the second terminal.

According to this example, the invention makes it possible to approximate the final tone despite one or more substances being unavailable or available only in a small quantity.

The table of correspondences may operate by major class of fragrances and propose, based on the proximity of the fragrances, other substances, by rectifying if necessary the quantities of the other substances. By way of example, if there is no vanillin, the table of correspondences indicates that ethylvanillin may be used instead. The table of correspondences may also specify that ethylvanillin must be used in a smaller quantity than vanillin, being more powerful than the latter. The table of correspondences may also comprise information indicating that the quantities of the other substances must be recalculated.

Each fragrant substance catalogued in the table of correspondences is for example associated with a list of similar substances. The degrees of proximity between fragrant substances are for example quantified by perfume experts.

A substance A is for example associated with six fragrant substances: a substance B, 90% similar to the substance A, a substance C, 80% similar to the substance A, a substance D, 70% similar to the substance A, a substance E, 60% similar to the substance A and a substance F, 50% similar to the substance A.

When it determines with the aid of the table of correspondences whether one at least of the fragrant substances listed in the optimized formulation and not available on the destination terminal may be replaced with at least one fragrant substance available on the destination terminal, the server may replace the unavailable substance with a substance from the list available on the terminal by decreasing degree of proximity.

If none of the substances available on the terminal appears in the list of substances associated with the substance listed in the formulation and not available on the terminal, the server may propose that the missing fragrant substance be sent to the terminal or may turn to an in-house expert to find an appropriate substance.

As a variant, the database is devoid of any correspondence table and the second terminal is configured to investigate whether the unavailable substance or substances figure among a mixture of substances contained in a reservoir, or else whether the unavailable substance or substances are contained in reservoirs with a different concentration.

As a further variant, when the server is not entirely automated, the substance or substances of the formulation to be obtained which are not available on the second terminal are replaced by the expert who uses his own experience.

The missing substance or substances may also be added on the second terminal. The server may for example prompt the user to dispose on the second terminal the unavailable substance or substances or, as a variant, one or more approximating substances, and designate the reservoirs to be drained so as to accommodate the substance or substances to be introduced. The substances corresponding to the reservoirs to be drained are for example chosen from among those which are not listed in the composition of the formulation, or else from among those which are used the least.

When the missing substance or substances are not immediately available, the server may send an order for the unavailable substance or substances to a central facility for sending substances.

As a further variant, the server chooses another second terminal, after having verified that the latter has at its disposal all the substances according to the formulation to be reproduced.

The invention is not limited to the comparison by the server of the substances of a formulation determined by the server with those available on the second terminal.

Such a comparison may also be performed by the second terminal when the latter is reproducing a formulation. In such a case, the memory associated with the second terminal comprises for example a correspondence table such as described above.

When the server is associated with reservoirs containing fragrant substances, the comparison operations described above may be performed by the server between the fragrant substances listed in a formulation described in the request sent by the first terminal and the fragrant substances at the disposal of the server.

The server may proceed as described above, if appropriate, with the aid of a table of correspondences between fragrant substances.

Manufacture and Packaging of the Perfume

The invention allows the user of the first terminal to send a request to reproduce a formulation according to one of the modes of reproduction to the server and to specify in the request an address to which the perfume thus manufactured should be dispatched, for example by a postal operator.

The perfume may be manufactured and packaged by a perfume manufacturing facility receiving instructions from the server.

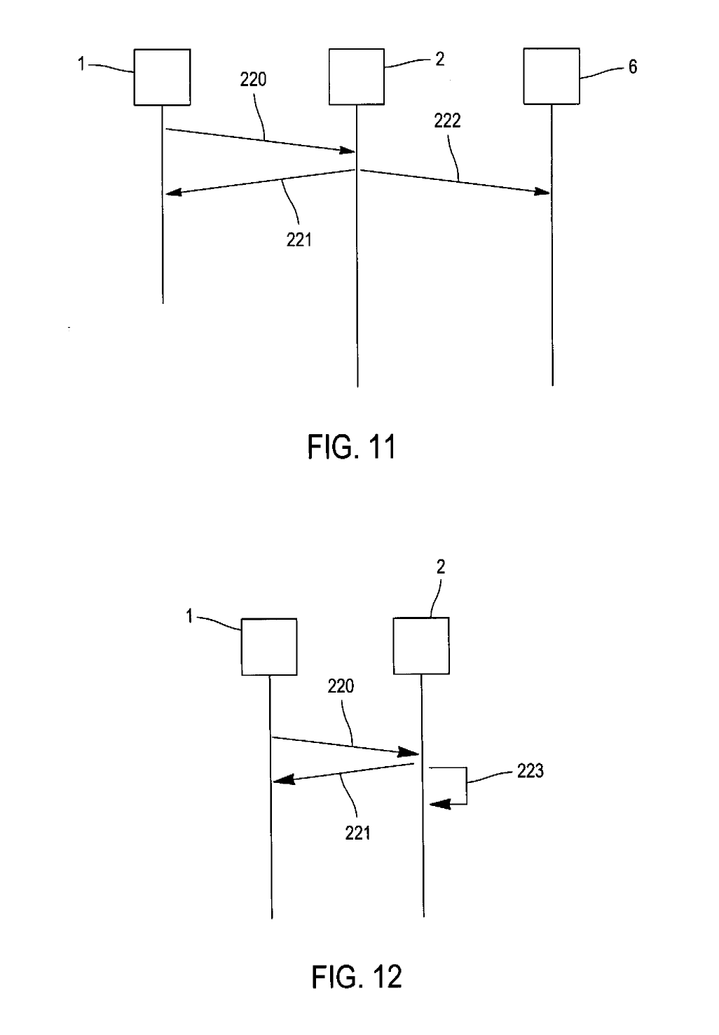

In the example of FIG. 11, the first terminal 1 sends a request 220 to the server 2 describing a formulation to be reproduced and for example an address to which the packaged perfume should be dispatched.

The server sends an acknowledgement message 221 to the first terminal 1 and then transmits to a perfume manufacturing facility 6 a request 222 comprising instructions relating to the formulation of the perfume to be manufactured and packaged and, if appropriate, an address to which the packaged perfume should be dispatched.

As a variant, the server is associated with reservoirs and with a dispensing means such as previously described and manufacture and packaging are carried out by the server, as represented in FIG. 12.

After receipt of the request 220, the server may manufacture and package the perfume according to instructions 223.

The perfume may be packaged in a bottle. The latter may be furnished with a leaktight stopper and/or dispensing means, for example a pump. The stopper means may comprise an applicator. The perfume capacity ranges for example from 1 ml to 2000 ml. The packaging may comprise a membrane intended to be set vibrating by an exciter member, in particular piezoelectric.

The perfume may also be packaged in a bottle or another packaging device bearing an electronic memory containing an audio and/or video file or a link making it possible to download such a file, as disclosed for example in patent application FR 2 905 568. The memory comprises for example information making it possible to identify the perfume manufactured and/or the fragrant substances listed in the corresponding formulation.

The perfume may also be manufactured by a second terminal receiving instructions from the server.

The perfume output of this second terminal comprises for example a pad configured to make it possible to maintain the perfume prepared at the disposal of the user. The pad is for example a foam, chosen from among flexible and non-absorbent materials, for example a polyurethane foam.

The perfume output of the second terminal may comprise a fritted pad.

On completion of the reproduction of the formulation, the pad containing the perfume is for example packaged and then sent to an address indicated by the user of the first terminal.

As a variant, the perfume output of the second terminal is equipped to receive bottles, or systems suitable for olfaction such as a respiration mask.

The packaged perfume may thereafter be delivered to a predefined address, for example the postal address of the user of the first terminal or of one of his or her acquaintances.

Programs for Preparing Formulations for Familiarizing Oneself with Fragrances and for Olfaction Education

According to an exemplary implementation of the invention, the memory associated with the terminals and/or the database associated with the server comprise one or more programs intended to instigate the reproduction of one or more formulations. These programs are embedded during the manufacture of the terminals and/or server or loaded subsequently.

These programs make it possible to instigate reproductions of formulations, the latter possibly being reduced in certain cases to very simple mixtures, or indeed even to the substances alone and may allow a second terminal to manufacture and package a perfume on instructions from the server.

Independently of the manufacture and packaging of a perfume, the formulations produced according to these programs may make it possible to discover the possibilities of a terminal, to discover the possibilities of a substance or of a palette of substances, or else to educate one or more users to the world of perfumes.

The programs may further make it possible to reproduce formulations or to generate formulations on the basis of already defined formulations so as to appraise the tastes in olfactory terms of the user of the first terminal or of the expert associated with the server.

These programs may also allow the user of a first terminal and the expert associated with the server, or the users respectively associated with the first terminal and with a second terminal or a second terminal to agree on a common language to rate the perfume obtained by reproduction of a formulation. A descriptor may be defined on the basis of one and the same reproduced fragrance, this descriptor being for example recorded in the memory associated with each terminal and/or in the database associated with the server.

The programs may be accompanied by representation, for example a description of the substances listed in the formulation and their content. The representation may further correspond to images, texts, pieces of music, films and/or questionnaires.

The programs take for example the form of games.

Such programs make it possible to implement the invention in a recreational manner, and this may enhance the attraction of a user of a terminal to the invention and thus facilitate his or her education.

According to an exemplary implementation of the invention, the first terminal and the server may be used to care for or re-educate adults or children suffering for example from a loss of olfactory sensitivity, amnesia or else autism for example.

Programs for Discovering Formulations

Independently of the manufacture and packaging of a perfume, other programs may be recorded in the memory associated with a terminal and/or in the database associated with the server, these programs being able, when they are executed, to present new products, or existing products by reproducing formulations.

Programs may for example present products undergoing manufacture.

Programs may also present products by exhibiting the various elements of a range.

They may also present products by breaking down the various notes of the product.

Collaborative Work to Improve Formulations. Comparison of Formulations

As described previously, a first terminal and a server, or a first terminal and a second terminal, or indeed even two servers, may exchange information to develop formulations.

As has been seen, a first terminal sends for example the server a request comprising, in codified form, information relating to the manufacture of a perfume.

The formulation may be reproduced by one of the terminals and/or the server or be produced in descriptive form. The first terminal and/or the server and/or, if appropriate, a second terminal, may moreover propose suggestions, or indeed even send determined formulations, so as to improve the formulations.

The first terminal, the server and, if appropriate, a second terminal or another server may exchange information in the manner of a community or by blog. According to such an example, the information exchanged is at least in part disseminated to a group.

Each terminal and/or the server comprise for example a program for comparing formulations, this program detecting, with respect to formulations already recorded in memory or in the database, the identical formulations and/or the formulations approximating thereto, the formulations implementing equivalent fragrant substances and/or equivalent concentrations.

Systems for Disabling and Activating the Programs, Formulations and Substances

Each terminal and/or the server may comprise systems for disabling the programs described above and, if appropriate, optionally associated representations and questionnaires. These disabling systems make it possible for example to prohibit momentarily or otherwise the running of the programs.

The activation of the programs is for example possible after receipt by a terminal, respectively by the server, of a command sent by the server, respectively by a terminal.

As a variant, the disabling system is configured to prevent the activation of one or more programs only up to a predefined date or only for a predetermined duration. This predetermined duration corresponds for example to a prior duration of operation of a terminal.

As a further variant, the disabling system is configured to be deactivated after input on the user interface of a terminal and/or of the server of a given code, or else after connection to the terminal and/or to the server of a given computerized key.

The invention may thus make it possible to be able to discover a formulation only on a given date, the formulation being as described previously hidden in the memory associated with the terminal before receipt of a code.

The disabling system is for example arranged so as to allow the reproduction of a formulation only under predefined conditions or a predetermined number of times.

Transmission of the Formulations and Programs, Automatic Transmission of the Formulations

As described previously, the first terminal may receive formulations sent by the server or by a second terminal.

The transmission of the formulations and, more generally of the information between the server and the terminals may be performed by way of a wired or non-wired connection.

When the terminals and the server are situated remotely, the connection is for example a telephone or Internet connection, the terminals and the server comprising customary interface modules such as modems, routers or the like. The interface modules make it possible for example to effect a WiFi or else WiMAX connection.

When the terminals and the server are situated in proximity, the connection implements for example a wired link by way of a cable, an infrared link, a radio link, such as for example Bluetooth or ZigBee.

In another variant, the communications between the terminals and the server which are disposed in proximity to one another are performed by the introduction of information manually by the user of the terminals or the expert associated with the server, or electronically by way of a memory, such as for example a USB key or by sending by a relay apparatus, such as for example a portable telephone or a personal digital assistant.

Other communication means are also possible, such as the receipt by the user of each terminal, respectively the expert associated with the server, by speech, or by mail, fax or email, of a formulation, and the introduction of the latter into the memory of the said terminal, respectively of the server, with the aid of the user interface.

As a further variant, the server may transmit formulations or programs to several terminals.

The transmission may be provided with an encryption key.

In another variant, communications may take place between one at least from among the terminals and the server, and users not being associated with a terminal or not being experts associated with the server.

According to this variant, one or more formulations are for example sent to one at least of the terminals and of the server by way of an Internet or USB connection or by SMS, this list not being limiting.

According to one embodiment of the invention, each terminal, respectively the server, is configured to automatically transmit the previously determined formulations to the server, respectively to each terminal.

Each terminal may further send the devised formulations continuously and automatically to the server.

Consideration of Information to Assist the Customization of Mixtures

Programs for Identifying Preferences

The server is for example configured to take into consideration personal information catalogued in the user preferences recorded in the memory associated with the terminal of the user so as to propose formulations to the terminal.

Each terminal and/or the server may also comprise a comparison system, configured to evaluate whether a selection of preferred and/or detested fragrances which was performed by a user of the terminal approximates the selection performed by another person, a group of people, or a symbolic group of people.

The terminals and/or the server may also be configured to analyse the evolution of the formulations, so as to extract the preferential modifications that the users make.

Interface for Managing the Formulations Received and Sent

Each terminal may comprise an interface for managing the formulations received and sent.

The interface for managing the formulations received and sent of a terminal comprises for example an audible and/or visual indicator indicating that a formulation has been received from the server.

As a variant, the interface for managing the formulations received and sent is connected to a computerized and/or telephone network and sends a message, for example an SMS or an email, to the user of a terminal when a formulation has been received by the terminal.

The interface for managing the formulations received and sent is for example configured to record the formulations received in a directory of the memory associated with the terminal and to class them by type of substances, of formulation or according to the sender.

### EXAMPLES

Several examples of implementation of the invention will now be described.

In one example, the communication standard comprises three sections.

The first section is a chart of 4096 rows for example, each row corresponding to a predefined substance. Each row is for example filled in with a number ranging from 0 to 255.

The second section is as a set of comments, made up for example of 4096 ASCII characters.

The third section comprises information about the identifier of the user of the terminal, the date and the time of sending of the formulation, a number identifying the formulation, and a chart for example of eight rows, corresponding to the substances available on the terminal.

In the example considered, the communication standard does not contain any item of information about the nature and the description of the substances.

The terminal and the server may share one and the same conversion chart, making it possible to translate each substance into an olfactory descriptor and vice versa.

### Examples Involving Design, Preparation, Exchanges of Formulation and Exchanges of Experience

A first embodiment of a terminal 1 according to the invention will now be described, configured to operate according to the “perfuming” mode of reproduction described previously.

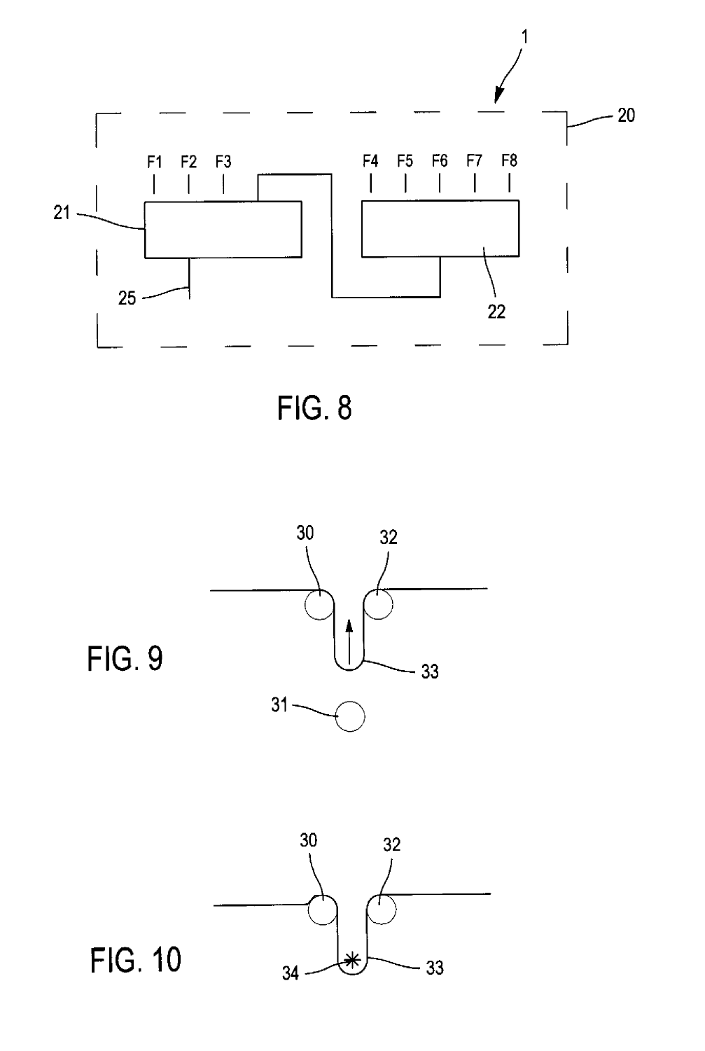

This terminal 1 is represented in a very schematic manner in FIG. 8.

According to this example, one and the same casing 20 encloses:
an ultracompact PC of PC type 104 marketed by the company ADVANTECH® under the reference PCM4170,
a 32-bit input output card suited to the PC format,
an eight-relay card suited to the PC format,
two microfluidics units 21 and 22 marketed by the company MICROLIQUID® under the reference 3020PCB, with six fluidic inlets and electrical connectors,
three 10-mL flexible plastic main reservoirs F1, F2 and F3 corresponding to complex fragrant substances, and
five 2-mL flexible plastic toning reservoirs F4 to F8 corresponding to simple fragrant substances.

The reservoirs and the microfluidics units are hooked up as represented in FIG. 8.

The outlet pipe 25 emerges on a disc, not represented, made of expanded polyurethane foam.

The eight reservoirs F1 to F8 are placed under mechanical pressure by a plate system borne on by three steel springs.

The PC comprises a screen, a keyboard and a mouse.

An exemplary program of the PC of a terminal will now be described according to the “perfuming” mode of reproduction, the description which follows applying equally well to the first terminal 1, to the second terminal 3 and to another terminal 4.

The PC 104 comprises the following programs:
a boot interface program, called “I-Boot”, which asks the user of the terminal whether he or she has modified the location of the substances or changed substances. If so, the user fills out a questionnaire through which he or she gives for each of the eight locations of reservoirs, the references in the form of a number lying between 0 and 4095, of the substances placed therein. This chart is called “Substance-location”,
an interface program “I-User” displaying on the screen three points symbolizing the three complex fragrant substances in the main reservoirs F1 to F3, and five vectors starting from these three points, symbolizing the five tonings possible with the aid of the five simple fragrant substances in the toning reservoirs F4 to F8.

This program brings about for example the display on the screen of the name of each of the substances, on the basis of a conversion chart common to the terminals and to the server, this conversion chart allying the references 0 to 4095 and the descriptions of each of the substances.

If the memory associated with the terminal contains formulations, whether they be received formulations or configured formulations, the last formulation to have been recorded is displayed on the screen in the form of a starting point and of vectors which are added thereto, and corresponding to the additions of the possible tonings. The screen also makes it possible, if appropriate, to display the other formulations if necessary.

By virtue of the user interface, the user may add or remove toning vectors and/or choose a complex starting perfume. The choice of the complex starting perfume is for example performed by entering into three sub-memories, respectively associated with a complex starting substance, either the value 0, or the value 100. One or more toning vectors may also be chosen, which may be, for each toning vector, a multiple of 5%. These vectors are associated with five sub-memories, called V1 to V5, it being possible for a value lying between 0 and 100 to be input into each of the said sub-memories.

The interface may further allow the user to introduce comments in the form of 4096 alphanumeric characters.

The PC may further comprise:
a formulation calculation program “Formulation Calculation”, creating, referencing each time a chart made up of the 4096 rows corresponding to each of the 4096 conceivable substances. This chart is called for example “Formulation”. The program is configured to introduce into each of the rows of the chart, in place of the reference of the substance, the values D1, D2, D3, V1, V2, V3, V4, V5 while reducing each value by dividing them by the value (D1+D2+D3+V1+V2+V3+V4+V5),
a formulation transmission program called “Formulation transmission”, by which, by way for example of an integrated ADSL modem of the PC, the terminal sends the formulation files, the comments file and the “user” file. This user file has for example a size of about 4096 bytes and may contain the following data: the user's code, the date and time of sending, the “substance-location” chart. The “Formulation-transmission” program also allows the receipt by the terminal of the formulation files, the generation of an alert destined for the user by showing on the screen the date and time of receipt of the formulation, as well as the formulation expressed by the list of substances thereof. This program also makes it possible to analyse the reproduction of the formulation by running, subject to the user's agreement, the program “I-Preparation” described above.
an interface program for preparation for reproduction “I-Preparation”, by which the interface verifies the appropriate fit between the substances of the formulation and the substances available on the terminal, forewarns the user if a substance is missing and requests the quantity of perfume to be prepared as well as the authorization to activate the reproduction program,
a program for reproducing the formulations called “formulation reproduction”, by which the terminal converts the formulation into substance(s) to be activated by producing an eight-row file called “substances activation”, corresponding to each substance and by allocating the value of the “formulation” chart, multiplied by the quantity of perfume to be prepared, introduced previously. This program also actuates the valves of the dispensing means for a given time, corresponding, for each valve of each substance, to the value of the “substances activation” chart, multiplied by the value 0.01 so as to allow the conversion from percentage values to real quantities. The program for reproducing the formulations may furthermore compare the quantity of perfume to be prepared and, if this quantity is greater than two grams, not reproduce the formulation with the aid of the terminal, the latter being configured to operate according to the “perfuming” mode of reproduction. The terminal may then send a server a request to reproduce the formulation.

In an exemplary use of the invention, two users each have a terminal such as described previously at their disposal, which will be called first and second terminal.

The reservoirs F1 to F8 of each of the terminals are, in the example described, filled with fragrant substance, with 25% active material and 75% ethanol:
F1 corresponds to a complex perfume substance for conventional men, Aqua di Gio™ by GIORGIO ARMANI®,
F2 corresponds to a complex perfume substance for sporty men, Polo Blue™ by RALPH LAREN®,
F3 corresponds to a complex perfume substance for young men Armani Code™ by GIORGIO ARMANI®,
F4 corresponds to a simple substance with a woody dominant, originating for example from sandalwood, cedar wood, or vetiver wood,
F5 corresponds to a simple substance with a hesperides dominant, such as an essential oil of lemon, an essential oil of bergamot or of neroli,
F6 corresponds to a simple substance with a musky dominant, such as white musk or galaxolide,
F7 corresponds to a simple substance with a marine dominant, such as calone,
F8 corresponds to a simple substance with a gourmand dominant, for example ethylmaltol or ethylvanillin.

In the example described the server is associated with a professional person, the perfume creator. The server comprises reservoirs containing the same substances as described above.

In this example the server also has at its disposal a stock of two hundred substances making up a fairly wide collection of the fragrant possibilities in the field of fragrances for alcoholic perfumes.

In the example described the server and the two terminals are linked via a telephone network connection accepting transmissions at 2 MB/s. The two users initially run the “I-Boot” program.

Several cases of use of the terminals will now be described.

### Example 1 of Use

### Order

The first terminal 1 sends the server 2 a request describing a devised formulation, placing an order for it. The server reproduces or arranges for the reproduction of the formulation in the required quantity so as to send it to an address associated with the first terminal 1.

### Example 2 of Use

### Sharing

The first terminal receives a formulation from another terminal, compares this formulation with the various formulations already recorded in memory, and then decides to reproduce the formulation by sending to the server 2 a request to manufacture and package the perfume according to the formulation.

### Example 3

### Product Intended for “Women”

Two users having no particular knowledge as regards perfume, are furnished with a terminal such as described previously.

Each terminal comprises eight reservoirs F1 to F8 filled with perfuming substance, with 25% active material and 75% ethanol. F1 to F3 are main reservoirs and F4 to F8 are toning reservoirs.

F1 corresponds to a complex perfume substance for women for example, Emporio White She™ by GIORGIO ARMANI®.

F2 corresponds to a complex perfume substance for women for example, Armani Code™ by GIORGIO ARMANI®.

F3 corresponds to a complex perfume substance for women for example Hypnose™ by LANCOME.

F4 corresponds to a simple substance with a floral dominant, such as the absolute of jasmine or lilial.

F5 corresponds to a simple substance with an oriental dominant, such as patchoulol.

F6 corresponds to a simple substance with a hesperides dominant, such as an essential oil of lemon, bergamot or neroli.

F7 corresponds to a simple substance with a fruity dominant, such as gamma-decalactone.

F8 corresponds to a simple substance with a gourmand dominant, such as ethylmaltol or ethylvanillin.

Each user prepares perfumes by mixing the bottles F1 to F8 and transmits according to the standard previously described the formulations reproduced to the other user.

Each user may then reproduce the formulations received and make comments on the impressions felt, and this may allow them to improve the formulations that they have configured by themselves. Each user may transmit a formulation reproduction request to the server so that the latter reproduces the formulation, or arranges for it to be reproduced.

### ANOTHER EXAMPLE

According to a second embodiment of terminal configured to operate according to the “perfuming” mode of reproduction, the terminal is devoid of microfluidics units.

In this example the eight reservoirs F1 to F8 are connected to a mixing chamber by flexible pipes.

The pipes are parallel. Midway along, they follow a curvature imposed by three idlers, 31 and 32, as represented in FIG. 9.

As may be seen, the axis of the intermediate idler 31 is mounted on a rail and may be displaced vertically by a stepper motor, not represented. By rising, the pipe 33 is less squashed and allows the fluid to flow.

According to this embodiment the PC comprises eight stepper motors driven with the aid of an eight-channel control card and actuates the flow of one or more other fluids by operating each of the eight motors.

According to a variant of this second embodiment, represented in FIG. 10, the intermediate idler 31 is replaced with a gearing 34.

The spindle of this gearing is rotary and may be driven by a stepper motor, so as to make the liquid circulate.

### Exemplary Embodiment of a Server Configured to Operate According to the “Manufacturing” Mode of Reproduction

Such a server may be embodied by enclosing in a first casing an ultracompact PC of PC type 104, for example marketed by the company ADVANTECH® under the reference PCM4170, a 32-bit input output card suited to the PC format 104 and a relay card 16 suited to the PC format 104.

A second casing, connected to the first, encloses sixteen plastic fluid reservoirs numbered C1 to C16 and each containing at least one substance. The bottles are linked by pipes 0.8 mm in diameter, to a mixing chamber, furnished with a stirring unit.

Microvalves marketed by the company SIRAI®, under the reference Plug-in microsolenoid valves (M8), V116B03-Z030B, are installed midway along the run of the pipes. These microvalves are of the “closed” type when they are not activated.

The mouth of the mixing chamber emerges in a recovery bottle.

The server is also furnished with a program making it possible to communicate by way of an ADSL modem with the terminals, and to receive perfume manufacture and packaging requests sent by the terminals. The program manages the manufacture and packaging requests, by associating for example with each manufacture and packaging, an address of the user of the terminal, for example his or her Internet address and/or his or her postal address.

The PC of the server receiving from a first terminal a request to manufacture and package a perfume reproduces the formulation described in the request in the required quantities.

An operator recovers the manufactured product and after having evaluated the quality of manufacture, and instructs for example the PC to send a message to the Internet address of the user to forewarn the latter that he or she will soon receive the manufactured and packaged perfume.

The operator may thereafter send the packaged perfume to the user, for example to his or her postal address.

The PC of the server may retain in memory the various requests, with the formulation of the perfume, and the quantities of manufactured perfume, doing so for each of the users of the terminals.

### ANOTHER EXAMPLE

The server is for example linked by the first casing to another server, configured to operate according to the “perfuming” mode of reproduction described previously, and to terminals by way of an ADSL modem.

The PC of the server configured to operate according to the “manufacturing” mode of reproduction and that according to the “perfuming” mode of reproduction exchange information, the PC according to the “perfuming” mode of reproduction being able for example to ask that according to the “manufacturing” mode to reproduce formulations.

The programming of the server according to the “manufacturing” mode of reproduction is for example the same as that of the terminal according to the “perfuming” mode of reproduction, except for the fact that it is suited to the valves described above and that it manages the mixing actions by actuating the stirring system as soon as the valves open and for five minutes.

As a variant, the outlet of the mixing chamber may comprise a so-called “2-way microsolenoid” valve from the M5 range, reference V165B03-Z030L.

### ANOTHER EXAMPLE

Another exemplary use of the invention will now be described.

According to this example a user is furnished with a terminal configured to operate according to the “perfuming” mode of reproduction such as described above.

Two servers are involved in this example:
a server configured to operate according to the “manufacturing” mode of reproduction, such as described above and
a server configured to operate according to the “perfuming” mode of reproduction,
   these two apparatuses being connected by USB port.

The user of the terminal, after having reproduced several formulations himself or herself and having used the perfumes obtained, decides to receive a formulation in a more sizable quantity. The terminal sends a request describing the formulation to the server configured to operate according to the “perfuming” mode of reproduction and asks to receive a sizable sample of 20 g.

The server configured to operate according to the “manufacturing” mode of reproduction reproduces the formulation on the instructions of the server configured to operate according to the “perfuming” mode of reproduction.

The invention is not limited to the examples which have just been described.

The expression “comprising a” should be understood as being synonymous with “comprising at least one”.

1. Method for preparing a perfume within a system comprising a plurality of interactive terminals for formulating perfumes and a server configured to exchange data with the plurality of terminals, each terminal comprising:
several fragrant substances making it possible when combined in various proportions to create a plurality of perfumes,
a dispensing means for dispensing a selection of the fragrant substances out of the terminal,
a user interface allowing a user of the terminal to devise, to select and/or to modify from the terminal a formulation of a perfume, the formulation comprising a list of fragrant substances to be combined and,
a network interface allowing the terminal:
to communicate with the server, so as to transmit to the server a formulation and/or,
to receive from the server data describing a formulation reproducible on the terminal on the basis of the fragrant substances available on the terminal or of fragrant substances that may optionally be disposed on the terminal, the method comprising:
transmitting, by a first terminal, a formulation to the server; and
manufacturing and packaging, on instructions from the server, a predefined quantity of a perfume corresponding to the formulation transmitted by the first terminal.

2. Method according to claim 1, wherein the formulation transmitted by the first terminal to the server is a formulation devised on the first terminal.

3. Method according to claim 1, wherein the formulation transmitted by the first terminal to the server is selected, if appropriate after having been modified, from among one or more formulations transmitted by another terminal of the plurality of terminals to the first terminal.

4. Method according to claim 1, wherein the formulation transmitted by the first terminal to the server is selected from among several formulations previously transmitted by the server to the first terminal.

5. Method according to claim 4, wherein user preferences are recorded in a memory associated with the first terminal and/or in a database associated with the server and wherein the formulation or formulations previously transmitted by the server to the first terminal are determined as a function of the user preferences.

6. Method according to claim 4, wherein the formulation or formulations previously transmitted by the server to the first terminal are optimized formulations determined as a function of a formulation devised on the first terminal.

7. Method according to claim 4, wherein the formulation or formulations previously transmitted by the server to the terminal are determined as a function of at least one olfactory descriptor present in a request addressed by the first terminal to the server.

8. Method according to claim 1, wherein the predefined quantity of perfume is manufactured and packaged by a second terminal of the plurality of interactive terminals receiving instructions from the server.

9. Method according to claim 8, wherein the second terminal is identified in a request transmitted by the first terminal to the server.

10. Method according to claim, 4, wherein the predefined quantity of perfume is manufactured and packaged by a second terminal of the plurality of interactive terminals receiving instructions from the server and wherein the formulation or formulations previously transmitted by the server to the first terminal are determined as a function of the fragrant substances available on the second terminal and/or of substances that may be disposed on the second terminal.

11. Method according to claim 8, wherein, the server transmits a request to the second terminal inviting a user of the second terminal to dispose on the second terminal one or more substances not available on the second terminal and listed in the formulation to be manufactured and packaged.

12. Interactive terminal for formulating perfumes, comprising:
a plurality of fragrant substances making it possible when combined in various proportions to create a plurality of perfumes,
a dispensing means making it possible to dispense a selection of the fragrant substances,
a user interface making it possible to devise, to select and/or to modify a formulation of a perfume with a view to manufacture and packaging of a predefined quantity of the perfume corresponding to the formulation, the formulation comprising a list of substances to be combined, and
a network interface making it possible to transmit to a server a formulation to be manufactured and packaged.

13. Terminal according to claim 12, wherein the dispensing means, the user interface and the network interface are incorporated in a single terminal.

14. Terminal according to claim 12, wherein the fragrant substances are contained in reservoirs capable of being placed in the terminal independently of one another.

15. Server configured to exchange data with a plurality of terminals, each terminal comprising:
several fragrant substances making it possible when combined in various proportions to create a plurality of perfumes,
a dispensing means for dispensing a selection of the fragrant substances out of the terminal,
a user interface allowing a user of the terminal to devise, to select and/or to modify from the terminal a formulation of a perfume, the formulation comprising a list of fragrant substances to be combined and,
a network interface allowing the terminal to communicate with the server, so as to transmit a formulation to the server and/or to receive from the server data describing a formulation reproducible on the terminal on the basis of the fragrant substances available on the terminal or of fragrant substances that may optionally be disposed on the terminal, the server being configured to do at least one of:
transmit to a first terminal one or more formulations determined as a function of user preferences associated with the user of the terminal and/or as a function of a formulation devised on the terminal and/or as a function of at least one olfactory descriptor contained in a request transmitted by the terminal to the server and/or as a function of fragrant substances available on the first terminal or on a second terminal identified by the first terminal or that may be disposed on the first terminal or on the second terminal, and
order the manufacture and the packaging of the perfume corresponding to at least one formulation devised, selected or modified by a first terminal, on a basis optionally of one or more formulations transmitted by the server to the first terminal.

16. Server according to claim 15 being configured to generate or select formulations as a function of at least one olfactory descriptor contained in a request transmitted by the first terminal to the server.

17. Server according to claim 16, having access to a chart for converting between olfactory descriptors and fragrant substances or associations of fragrant substances.

18. The method according to claim 3, the formulation transmitted by the first terminal to the server being selected from one or more formulations recorded in a memory associated with the another terminal.
